(19) United States
(12) Patent Application Publication
(10) Pub. No.: US 2011/0284707 A1
(43) Pub. Date: Nov. 24, 2011

(54) OVER-THE-DOOR HANGIT SYSTEM

(76) Inventors: Patrice Adams, Des Moines, WA (US); Patrick Adams, Des Moines, WA (US)

(21) Appl. No.: 13/108,767

(22) Filed: May 16, 2011

Related U.S. Application Data
(60) Provisional application No. 61/345,688, filed on May 18, 2010.

(51) Int. Cl. F16M 13/02; F16B 2/20

(52) U.S. Cl. 248/225.21; 248/205.1

(57) ABSTRACT

An Over-The-Door Hangit system comprising: at least one strap; at least one bracket; at least one buckle(s); and a plurality of grommets having attachers. The bracket is positioned at a top portion of the door, and is designed to hold the strap securely in place. The buckles are removably-attachable at a first end and a second end of strap. Further, the buckle(s) allow for adjustment of the strap between tightened and loosened conditions. The strap wraps under the door and then connects at the top portion of the door to the bracket thereby providing one vertical hanging surface on each side of the door. Additionally, the strap comprises the plurality of grommets with the attachers being used to slip into the grommets to removably-support and display items in a vertical hanging condition.

### CROSS-REFERENCE TO RELATED APPLICATION

The present application is related to and claims priority from prior provisional application Ser. No. 61/345,688, filed May 18, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of hangers and more specifically relates to a hanger for use on a door to vertically hang and display various items.

2. Description of the Related Art

Currently, consumers are always seeking new methods for displaying art, decorations, and storing items that are not in use such as on doors or walls. For example, users may use the inner side of a door to hanging clothes or other decorative articles on coat hooks or the like. Many people do not like to hang pictures with nails because holes and cracks may form in their walls compromising the wall and/or door finish(es). Due to limited space constraints and for convenience sake, users currently may use nail hanging hooks or use organizers that attach to a wall of a bedroom or bathroom. Additionally, the standard hanging hooks are removably-attached to the wall via screws, nails, or tape which may pose several problems such as the difficulty of installation along with the limited strength of these various attachers. Also, these attachers may damage surrounding areas that they may attach to.

For example, taping art and pictures to doors and walls can be a hassle, as tape may not be strong enough to hold these items for extended periods of time. Unfortunately, tape can also leave behind sticky residue which may be both unsightly and difficult to remove. Storage is also a problem for many consumers. Items such as jackets, backpacks, hats, purses, bathrobes, and towels that are used frequently should be made accessible without causing clutter. A viable, non-destructive hanging/storing solution is desirable.

A strap is an elongated flap or ribbon, usually made of fabric or leather. Thin straps are used as part of clothing or baggage, or bedding such as a sleeping bag. A strap differs from a belt mainly in that a strap is usually integral to the item of clothing; either can be used in combination with buckles. Straps are also used as fasteners to attach and bind items, to objects, animals and people. Occasionally a strap is specified after what it binds or holds, e.g. chin strap. Straps typically hold item(s) in place on horizontal surfaces, thus substantially preventing them from shifting positions. Therefore, a convenient and effective solution that is simple to use and install is necessary.

Various attempts have been made to solve the above-mentioned problems such as those found in U.S. Pat. Nos. 4,846,430; 2,925,916; 7,131,546; 2003/0085188; 5,788,093; and 2007/0262226. This prior art is representative of hangers and/or organizers. None of the above inventions and patents, taken either singly or in combination, is seen to describe the invention as claimed.

Ideally, an over-the-door hangit system should be user-friendly, easy to install and yet, would operate reliably and be manufactured at a modest expense. Thus, a need exists for a reliable over-the-door hangit system that may be removably-attachable to a door to vertically hang and display various items.

### BRIEF SUMMARY OF THE INVENTION

In view of the foregoing disadvantages inherent in the known hanger art, the present invention provides a novel over-the-door hangit system. The general purpose of the present invention, which will be described subsequently in greater detail, is to provide an over-the-door hangit system that permits users to vertically hang and display various items on virtually any door while conserving space on walls and shelves. This unique product provides a surface on which children's art and decorative objects may be displayed while also conveniently hanging essential items on both the inside and outside of doors. The strong and easily adjustable attachers such as hooks may be used to hold items such as backpacks, jackets, hats, purses, and other frequently-used items, keeping them easily accessible while minimizing clutter.

The present invention, over-the-door hangit system as disclosed herein preferably comprises: at least one strap; at least one bracket; at least one (cam or the like) buckle(s); and a plurality of grommets having attachers. The strap preferably comprises nylon or vinyl (or other suitable material) and is adjustable. Further, the strap is about one-inch thick in width. The strap may wrap under a vertical door and then connect at a top portion of the door to the bracket thereby providing at least one hanging surface on each side of the door. Further, the strap preferably comprises a plurality of grommets. The grommets may comprise metal (or other suitable material) and are vertically spaced approximately six-inches apart on the strap.

The bracket may be U-shaped and may comprise metal in preferred embodiments. The bracket is positionable at a top portion of the door, and is designed to hold the strap securely in place. The bracket is preferably bent into the u-shape with about a ¼-inch by about a 1 ½-inch hole on both sides of the bracket for the strap to slide through and connect to the buckle(s).

The cam buckle(s) are removably-attachable at a first end and a second end of strap, with the buckle(s) allowing for adjustment of the strap between tightened and loosened conditions. The buckle(s) allow for easy adjustment to tighten or loosen the strap, as desired.

The attachers (slip in custom hooks) are used to slip into the grommets to removably-support and display items in a vertical hanging condition. The attachers comprise a plurality of biasing clips (hooks), however other attachers such as binder clips or clothespin-style clips may be used to secure items such as photos directly to the strap.

A kit is also embodied herein for the over-the-door hanging system comprising: at least one strap; at least one bracket; at least two buckle(s); the strap(s) having a plurality of grommets therein; a plurality of attachers (biasing clips); and a set of user-instructions for installation and use.

In accordance with the embodiments of the present invention a preferred method of use is disclosed herein comprising: step one installing at least one bracket onto a top portion of a door; step two sliding a strap through a hole on the bracket; step three adjusting the strap via buckles to a user-preferred tightness; step four inserting attachers (biasing clips) onto the strap; and step five hanging user-preferred items on the strap for display and/or storage.

The present invention holds significant improvements and serves as an over-the-door hangit system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, over-the-door hangit system, constructed and operative according to the teachings of the present invention.

FIG. 1 shows a perspective view illustrating an over-the-door hangit system in an ‘in-use’ condition according to an embodiment of the present invention.

FIG. 2 shows a perspective view illustrating an over-the-door hanger with attachers of the over-the-door hangit system to an embodiment of the present invention.

FIG. 3 shows another perspective view illustrating the over-the-door hanger with attachers of the over-the-door hangit system to an embodiment of the present invention.

FIG. 4 is perspective view illustrating the over-the-door hangit system in another ‘in-use’ condition according to an embodiment of the present invention.

FIG. 5 is perspective view illustrating the over-the-door hangit system in yet another ‘in-use’ condition according to an embodiment of the present invention.

FIG. 6 is a flowchart illustrating a method of use for the over-the-door hangit system according to an embodiment of the present invention of FIGS. 1-5.

The various embodiments of the present invention will hereinafter be described in conjunction with the appended drawings, wherein like designations denote like elements.

### DETAILED DESCRIPTION

As discussed above, embodiments of the present invention relate to field of hangers and more specifically relates to a hanger for use on a door to vertically hang and display various items.

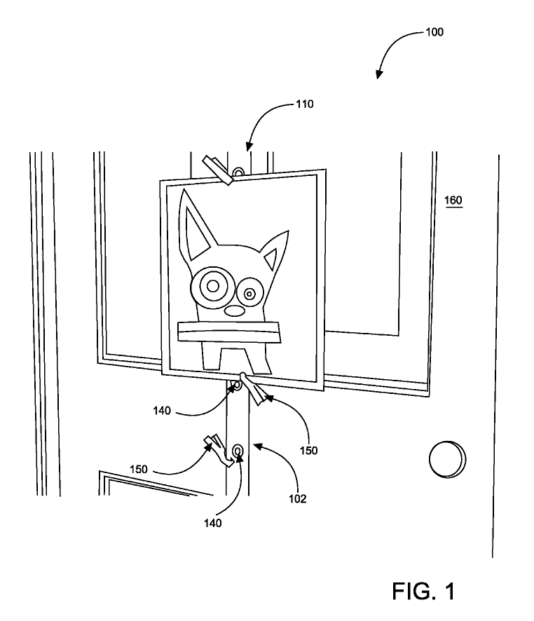

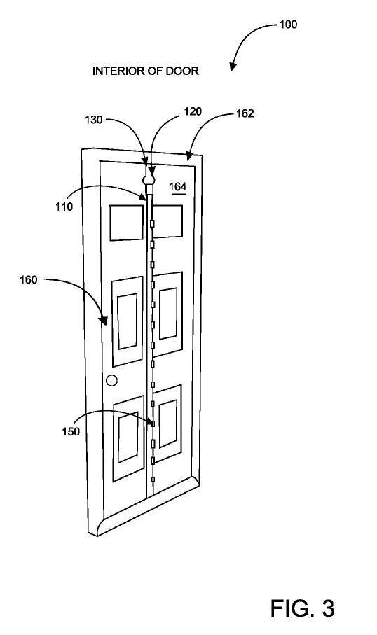

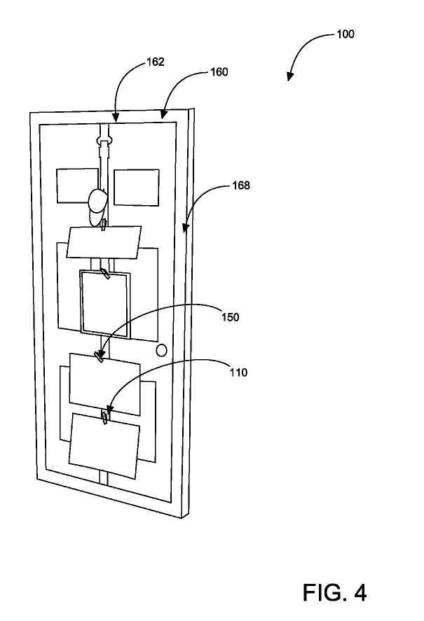

Referring now to FIGS. 1-5 showing perspective views of over-the-door hangit system 100 according to an embodiment of the present invention. Over-the-door hangit 100 preferably comprises over-the-door hanger 102. Over-the-door hanger 102 allows users to vertically hang and display various items on virtually any vertical door (door 160) as shown in FIGS. 1, 4, & 5. Over-the-door hanger 102 provides a safe and secure surface to hang or display items on both inside portion 164 and outside portion 168 of door 160.

Over-the-door hanger 102 may be ideal for use on door 160 such as in a bedroom, a dorm room (possibly in school colors and logos), pantry, laundry, or a closet. Further, over-the-door hanger 102 is a useful storage solution in virtually any house, apartment, condo, or place of business. Over-the-door hanger 102 may also be used outside on door 160 of a pool house to hang towels, bathing suits, goggles, flippers, etc., or on the shed for hanging small hand tools, gloves, and the like. Over-the-door hanger 102 preferably utilizes both sides of door 160 (inside portion 164 and outside portion 168) and may be used both indoors and outdoors. The consumer has endless options of items that can be hung and at any desired user-preferred height when using over-the-door hanger 102 of over-the-door hangit system 100.

Over-the-door hanger 102 preferably comprises at least one strap 110; at least one bracket 120; at least one buckle(s) 130; and a plurality of grommets 140 having attachers 150.

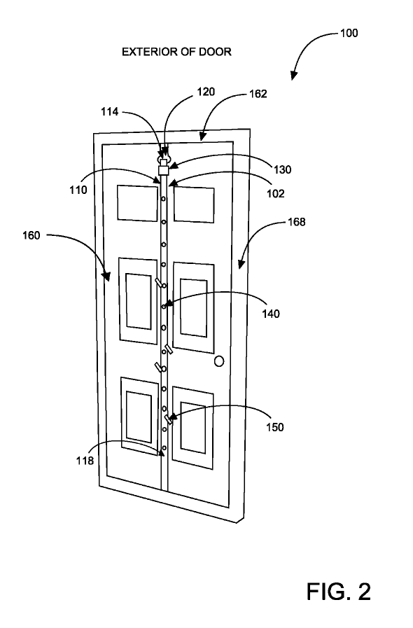

Strap 110 may be about one-inch in width and is preferably adjustable via buckle(s) 130. Buckle(s) 130 are preferably removably-attachable at first end 114 and second end 118 of strap 110 and may comprise cam-type buckle(s) 130 as shown in FIGS. 2-4. Further, buckle(s) 130 allows for relatively easy adjustment of strap 110 between tightened and loosened conditions as when installing or removing over-the-door hanger 102 from door 160. In this way the present invention may be suitably tensioned or loosened as needed when in loaded and unloaded conditions.

Additionally, strap 110 comprises either nylon or vinyl or other suitable material. Upon reading this specification, it should be appreciated that, under appropriate circumstances, considering such issues as user preferences, design preference, structural requirements, marketing preferences, cost, available materials, technological advances, etc., other materials for strap 110 may be used such as, for example, other forms of plastic, rubber, canvas, fabric, non-fabric, etc., may be sufficient.

Bracket 120 may be positioned at top portion 162 of door 160, and is designed to hold strap 110 securely in place. Additionally, bracket 120 may made from about 22 gauge sheet-metal, however other materials may be used. Strap 110 may wrap under door 160 and then connect at top portion 162 of door 160 to bracket 120 thereby providing at least one vertical hanging surface on each side of door 160 (inside portion 164 and outside portion 168) as shown in FIGS. 2 & 3.

Strap 110 preferably comprises a plurality of grommets 140. Grommets 140 may comprise metal and may be vertically spaced approximately six-inches apart on strap 110 (along a vertical centerline.) Bracket 120 may be bent into a u-shape with about a ¼-inch by about a 1 ½-inch hole on both sides of bracket 120 for strap 110 to slide through and connect to buckle(s) 130. Further, buckle(s) 130 may be powder coated, enamel, or alternate coating to protect door 160 from scratches. In this way (and others) the present invention provides a non-evasive means to hang/store items such that the door is not in any way compromised or destroyed.

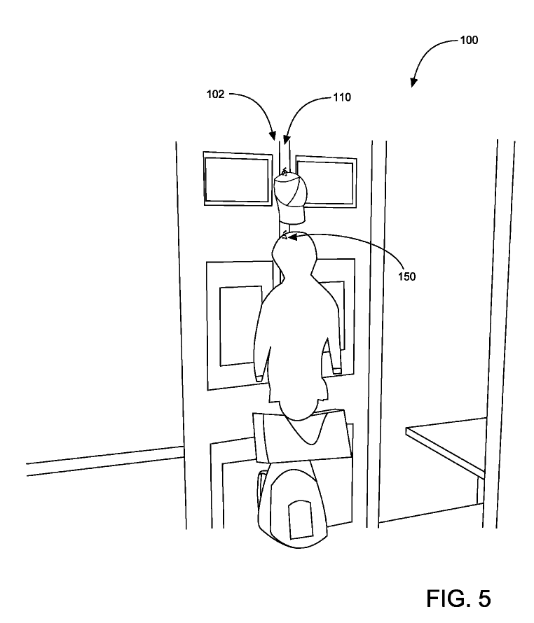

Attachers 150 may be used to slip into grommets 140 to removably-support and display items in a vertical hanging condition as shown in FIGS. 1, 4, & 5. Attachers 150 preferably comprise a plurality of biasing clips (hooks). When biasing clips (hooks) are used as attachers 150, items such as backpacks, jackets, hats, purses, robes, purses, towels, and other items may be temporarily be hung on door 160, keeping them easily accessible while minimizing clutter as shown in FIG. 5.

When clips such as binder clips, paper clips, chip clips or even clothespins are used as attachers 150 artwork such as children's art, paintings, photos, or even Christmas cards may be easily displayed all at once on door 160 when using over-the-door hanger 102. Friends can clip notes on the outside of the door using a wide variety of clips as attachers 150 while the inside is being utilized for hanging personal items such as a backpack, jacket, robe, or towel as suitable inside a dorm-room thereby virtually eliminating the need for adhesive tape. For example in a child's room, the child's art can be displayed proudly on outside portion 168 of door 160 while inside portion 164 is utilized for hanging virtually anything from stuffed animals to personal or school items. Businesses may also benefit from using over-the-door hangit system 100 such as on door 160 of an office or even pods to hang personal items, valuable information or signs.

Over-the-door hangit system 100 according to an embodiment of the present invention of FIGS. 1-5 may comprise kit 540. Kit 540 may comprise the following parts: at least one strap 110; at least one bracket 120; at least one buckle(s) 130; (the strap(s) 110 having a plurality of grommets 140); a plurality of the attachers 150; and a set of user-instructions for installation and use.

Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately.

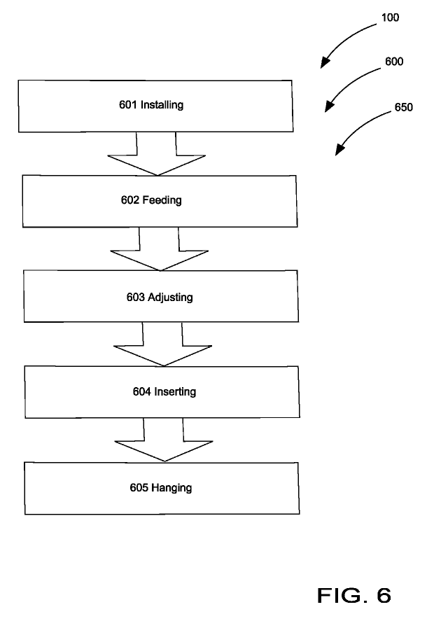

FIG. 6. shows flowchart 650 illustrating method of use 600 according to an embodiment of the present invention of FIGS. 1-5. A method of using (at least herein enabling method of use 600) over-the-door hangit system 100 may comprise the steps of: step one 601 installing at least one bracket 120 onto top portion 162 of door 160; step two 602 sliding strap 110 through a hole on bracket 120; step three 603 feeding strap 110 through a portion of buckle(s) 130, then through the hole in bracket 120, then back through another portion of buckle(s) 130 thereby locking a top of strap 110 in place; step four 604 placing strap 110 under door 160 and up the other side, then attaching another portion of the buckle(s) 130 to the other end of strap 130; step five 605 sliding strap 110 through the other side of the hole in bracket 120 and then back through the other portion of buckle(s) 130, then pulling strap 110 tight and locking in place; step six 606 inserting attachers 150 (biasing clips) onto strap 110; and step seven 607 hanging user-preferred items on strap 110.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An over-the-door hanging system comprising:
at least one strap having a first end and a second end of said strap;
at least one bracket;
at least one buckle(s); and
a plurality of grommets having attachers;
wherein said bracket is positioned at a top portion of said door, and is designed to hold said strap securely in place;
wherein said buckle(s) is removably-attachable at said first end and said second end of said strap, said buckle(s) allowing for adjustment of said strap between tightened and loosened conditions;
wherein said strap wraps under said door and then connects at said top portion of said door to said bracket thereby providing one vertical hanging surface on each side of said door;
wherein said strap comprises said plurality of grommets; and
wherein said attachers are used to slip into said grommets to removably-support and display items in a vertical hanging condition.

2. The over-the-door hanging system of claim 1 wherein said strap is about one-inch in width.

3. The over-the-door hanging system of claim 2 wherein said strap comprises nylon.

4. The over-the-door hanging system of claim 2 wherein said strap comprises vinyl.

5. The over-the-door hanging system of claim 2 wherein said strap is adjustable.

6. The over-the-door hanging system of claim 1 wherein said bracket is U-shaped.

7. The over-the-door hanging system of claim 1 wherein said bracket comprises metal.

8. The over-the-door hanging system of claim 1 wherein said buckle comprises a cam buckle.

9. The over-the-door hanging system of claim 1 wherein said attachers comprise a plurality of clips.

10. The over-the-door hanging system of claim 9 wherein said clips are biasing.

11. The over-the-door hanging system of claim 1 wherein said attachers comprise binder clips.

12. The over-the-door hanging system of claim 1 wherein said attachers comprise clothespin-style clips to secure items such as photos directly to said strap.

13. The over-the-door hanging system of claim 8 wherein said buckle(s) allows for easy adjustment to tighten or loosen said strap.

14. The over-the-door hanging system of claim 1 wherein said grommets comprise metal and are vertically spaced approximately six-inches apart on said strap.

15. The over-the-door hanging system of claim 1 wherein said bracket comprises about a ¼-inch by about a 1 ½-inch hole on both sides of said bracket for said strap to slide through and connect to said buckle.

16. An over-the-door hanging system comprising:
at least one one-inch in width nylon strap;
at least one U-shaped metal bracket;
at least one cam buckle(s); and
a plurality of grommets having biasing clips;
wherein said U-shaped, metal bracket is positioned at a top portion of said door, and is designed to hold said nylon strap securely in place;
wherein said cam buckles are removably-attachable at a first end and a second end of said strap, said cam buckle(s) allows for adjustment of said strap between tightened and loosened conditions;
wherein said nylon strap wraps under said door and then connects at said top portion of said door to said bracket thereby providing one vertical hanging surface on each side of said door;
wherein said nylon strap comprises said plurality of grommets; and
wherein said biasing clips are used to slip into said grommets to removably-support and display items in a vertical hanging condition;
wherein said buckle(s) allow for easy adjustment to tighten or loosen said strap;
wherein said grommets comprise metal and are vertically spaced approximately six-inches apart on said strap; and
wherein said bracket comprises about a ¼-inch by about a 1 ½-inch hole on both sides of said bracket for said strap to slide through and connect to said buckle.

17. The over-the-door hanging system of claim 16 further comprising a kit including said at least one strap; said at least one bracket; said at least one buckle(s); a plurality of said attachers; and a set of user-instructions for installation and use.

18. A method of using an over-the-door hanging system comprising the steps of:
installing at least one bracket onto a top portion of a door;
sliding a strap through a hole on said bracket;
adjusting said strap via buckle(s) to a user-preferred tightness;
inserting attachers onto said strap; and
hanging user-preferred items on said strap.
